(19) United States
(12) Patent Application Publication
(10) Pub. No.: US 2014/0052333 A1
(43) Pub. Date: Feb. 20, 2014

(54) Image Recognition System For A Vehicle

(71) Applicant: Guy Elder, Petersburg, VA (US)

(72) Inventor: Guy Elder, Petersburg, VA (US)

(21) Appl. No.: 13/585,318

(22) Filed: Aug. 14, 2012

(51) Int. Cl. G06F 17/00

(52) U.S. Cl. CPC G06F 17/00
USPC 701/36

(57) ABSTRACT

An image recognition system for a vehicle that may include: at least one camera mounted within an interior of the vehicle, where camera monitors a driver of the vehicle; an operating system controlling the at least one camera, where the operating system includes image recognition software, a database of authorized users based upon user images, an interconnection to a vehicle control system and a processor; and a keypad, where the keypad enables the entry of authorized users into the database of authorized users. A first camera of the recognition system may be positioned along a perimeter of a windshield of the vehicle and/or a second camera may be positioned adjacent to a rearview mirror of the vehicle. During operation the at least one camera scans for an image of the driver and compares the image to the user images stored on the database of authorized users, if the image of the driver not match any user images stored on the database of authorized users, the operating system initiates a non-operable mode for the vehicle. In one exemplary embodiment, the at least one camera also monitors the driver's head and eye movement, and the operating system initiates an audible alert upon detecting impairment of the driver based upon the driver's head and eye movement.

### BACKGROUND OF THE INVENTION

1. Field of Invention

The present invention relates to an image recognition system for a vehicle that recognizes the facial features of the user to provide security and safe driving for the user.

2. Description of Related Art

The need for vehicle security is important to secure a vehicle from theft. Certain deterrents to prevent vehicle theft include vehicle alarms, special locking mechanisms, vehicle tracking systems, door locks and other simple security systems for a vehicle. Most vehicles use a key to start the ignition for use of a vehicle, thus providing one means of security. However these have various techniques have been developed by thieves to overcome the necessity of a key to start a motor vehicle. Further thieves also have systems available to overcome various alarm systems that may be implemented on motor vehicles. Consequently, it is necessary to further develop even more secure vehicle security systems to prevent vehicle theft. In particular using image recognition to secure a vehicle from theft.

### SUMMARY OF THE INVENTION

The present invention relates to an image recognition system for a vehicle comprising: at least one camera mounted within an interior of the vehicle, where camera monitors a driver of the vehicle; an operating system controlling the at least one camera, where the operating system includes image recognition software, a database of authorized users based upon user images, an interconnection to a vehicle control system and a processor; and a keypad, where the keypad enables the entry of authorized users into the database of authorized users. A first camera of the recognition system may be positioned along a perimeter of a windshield of the vehicle and/or a second camera may be positioned adjacent to a rearview mirror of the vehicle. During operation the at least one camera scans for an image of the driver and compares the image to the user images stored on the database of authorized users, if the image of the driver not match any user images stored on the database of authorized users, the operating system initiates a non-operable mode for the vehicle. In one exemplary embodiment, the at least one camera also monitors the driver's head and eye movement, and the operating system initiates an audible alert upon detecting impairment of the driver based upon the driver's head and eye movement.

### BRIEF DESCRIPTION OF DRAWINGS

FIG. 1 is an image recognition system for a motor vehicle in accordance with the present invention.

### DETAILED DESCRIPTION

The present invention relates to an image recognition for a motor vehicle. The image recognition system includes the use of cameras inserted in the interior of the motor vehicle. The cameras recognize the facial features of the owner and/or driver of the vehicle. The image recognition enables or secures the vehicle and keeps the vehicle in a non-operational mode until the image of the driver is recognized through the use of software implemented in conjunction with the image recognition cameras in the vehicle. The image recognition may be initially set by the manufacturer or a dealer through the use of a keypad that provides a bypass to set up the image recognition. Further the camera systems in the vehicle may also recognize head movement and eye movement to associate it with the driver while the vehicle is in operation. The image recognition system utilizes the operative computer system in the vehicle to first secure the vehicle from use by non-authorized user. The system further recognizes if the user is dosing off based upon head movement and closure of the driver's eyes for a pre-determined period of time. If the driver indicates non-movement or movements associated with being impaired the system will emit a warning buzzer and actually decrease the speed of the vehicle by application of the brakes via the vehicle computer control system.

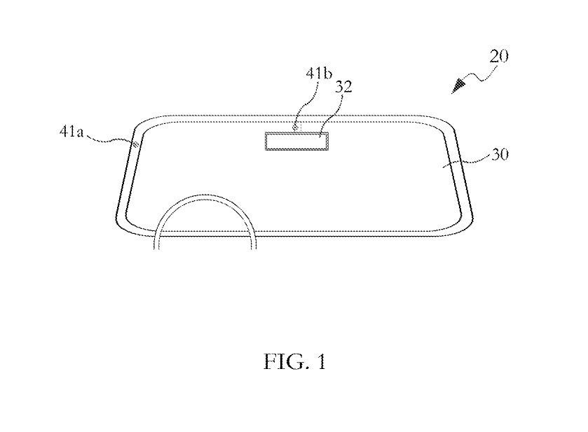

In reference of FIG. 1, an overview of the image recognition system 20 in accordance with the present invention as depicted. The image recognition system 20 implements the use of at least one camera installed in the front windshield area of the vehicle. As shown in FIG. 1, a first camera 41a is positioned near the driver's side along the perimeter of a windshield 30. The second camera 41a may also be implemented near a rearview mirror 32. These cameras 41a, 41b may be used exclusively or together to recognize the facial features of the driver once the driver is in the vehicle. The driver must ensure that his face is visible to the camera prior to starting the vehicle for operation. If the system fails to recognize the driver the system places the vehicle in a non-operative mode and will therefore secure the vehicle from any unauthorized use. This particular system may be initially implemented through the use of a key pad, not shown, provided on the dash or console of the vehicle. This system enables the user to verify and authorize drivers of the vehicle through the camera's imaging system. Consequently each authorized driver must be photographed through the cameras provided in the imaging system. This image is saved in the memory of the computer system associated with the image recognition system. The keypad provides a code to override the imaging system and to allow for any unauthorized users to be added to the database of authorized users with the imaging system.

Further, cameras 41a, 41b remain operative during the operation of the vehicle. During the operation of the vehicle the cameras 41a, 41b recognize head movement and whether the driver's eyes are open. If the driver's head slumps or the retinas of the eyes aren't visible to the cameras then an audible buzzer sounds in order to wake the individual. Upon the awakening of the driver the buzzer shuts off. If the buzzer remains on and the camera do not recognize the driver's retinas, then the vehicle decelerates through application of brakes through the computer system of the vehicle.

The image recognition system is implemented by integrating the imaging cameras' software data with the vehicle's electronic system to ensure authorized use of the vehicle and to provide safe use of the vehicle by the driver. The image recognition system therefore monitors the driver upon the initial starting of the vehicle and throughout operation as a means to safely and securely operate the vehicle. The instant invention has been shown and described in what it considers to be the most practical and preferred embodiments. It is recognized, however, that departures may be made there from within the scope of the invention and that obvious modifications will occur to a person skilled in the art.

What is claimed is:

1. A image recognition system for a vehicle comprising:
a. at least one camera mounted within an interior of the vehicle, where camera monitors a driver of the vehicle;
b. an operating system controlling the at least one camera, where the operating system includes image recognition software, a database of authorized users based upon user images, an interconnection to a vehicle control system and a processor; and
c. a keypad, where the keypad enables the entry of authorized users into the database of authorized users.

2. The image recognition system according to claim 1, where a first camera is positioned along a perimeter of a windshield of the vehicle.

3. The image recognition system according to claim 1, where a second camera is positioned adjacent to a rearview mirror of the vehicle.

4. The image recognition system according to claim 1, where the at least one camera scans for an image of the driver and compares the image to the user images stored on the database of authorized users.

5. The image recognition system according to claim 4, where the operating system initiates a non-operable mode for the vehicle, should the image of the driver not match any user images stored on the database of authorized users.

6. The image recognition system according to claim 1, where the at least one camera monitors the driver's head and eye movement.

7. The image recognition system according to claim 6, where the operating system initiates an audible alert upon detecting impairment of the driver based upon the driver's head and eye movement.
